(19) United States
(12) Patent Application Publication
(10) Pub. No.: US 2007/0145109 A1
(43) Pub. Date: Jun. 28, 2007

(54) Asset management system

(75) Inventor: Jay Dawson, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/315,364

(22) Filed: Dec. 23, 2005

(51) Int. Cl. G06F 17/00

(52) U.S. Cl. 235/375

(57) ABSTRACT

An asset management system is provided. The system may include one or more data collection devices configured to monitor one or more operating conditions of a machine in real time. The system may also include a processor configured to receive data from the one or more data collection devices and compare the received data to a set of usage terms of a warranty agreement relating to the machine. The system may be configured to communicate, in real time, to at least one of an owner and an operator, information regarding the warrantability of the machine or its components under the warranty agreement. The communication of information may be based on the comparison of the received data to the set of usage terms of the warranty agreement.

### TECHNICAL FIELD

The present disclosure is directed to an asset management system and, more particularly, to an asset management system based on machine data acquisition.

### BACKGROUND

Over time, machines have become more and more technologically sophisticated. The evolution of computing technology, among other things, has spawned the development of better performing machines by facilitating more control of machine operating systems. Improved control may be enabled, in some cases, by monitoring the operating parameters of a system or component in “real-time.” Such monitoring may enable a system to respond in a precise and virtually immediate manner to maintain operating parameters to desired specifications.

Machine owners may be concerned with various aspects of machine operation, such as machine performance, operator conduct (e.g., abuse, productivity, etc.), efficiency, machine health, etc. In particular, the cost to maintain a machine can be a major economic factor in asset management. An expected cost to maintain a machine may be compared to depreciated value of the machine to determine when to replace the machine.

The same or similar types of monitoring equipment that are used to regulate performance of a machine may also be used to record operating conditions data that may be used to monitor the various aspects of machine operation mentioned above. Such data acquisition may be used to enforce warranty agreements. Systems have been developed that make use of such data acquisition in determining the remaining warranty coverage of a mobile asset. For example, U.S. Patent Publication No. US 2002/0065698 to Schick et al. (“the '698 document”), discloses determining, based on operation data, the remaining warranty coverage of machines.

While the '698 document may disclose determining the amount of warranty coverage remaining after a period of using a machine, neither the data nor any information related to the data is communicated, in real time, to an owner or an operator of the machine. Knowledge of whether a machine is being operated in compliance with a warranty, if provided in real time, may enable non-compliant operation to be addressed at the earliest stage. For example, the operation may be made compliant with the warranty by either changing the operation or changing the terms of the warranty.

The present disclosure is directed to overcoming one or more of the problems set forth above.

### SUMMARY OF THE INVENTION

In one aspect, the present disclosure is directed to an asset management system. The system may include one or more data collection devices configured to monitor one or more operating conditions of a machine in real time. The system may also include a processor configured to receive data from the one or more data collection devices and compare the received data to a set of usage terms of a warranty agreement relating to the machine. The system may be configured to communicate, in real time, to at least one of an owner and an operator, information regarding the warrantability of the machine or its components under the warranty agreement. The communication of information may be based on the comparison of the received data to the set of usage terms of the warranty agreement.

In another aspect, the present disclosure is directed to a method of asset management. The method may include monitoring one or more operating conditions of a machine in real time. The method may also include collecting data for the one or more operating conditions and comparing the collected data to a set of usage terms of a warranty agreement relating to the machine. The method may further include communicating, in real time, to at least one of an owner and an operator, information regarding the warrantability of the machine or its components under the warranty agreement. The communication of information may be based on the comparison of the collected data to the set of usage terms of the warranty agreement.

### BRIEF DESCRIPTION OF THE DRAWINGS

FIG. 1 is a diagrammatic illustration of an asset management system according to an exemplary disclosed embodiment.

FIG. 2 is a block diagram representation of an asset management system according to an exemplary disclosed embodiment.

### DETAILED DESCRIPTION

Reference will now be made in detail to the drawings. Wherever possible, the same reference numbers will be used throughout the drawings to refer to the same or like parts.

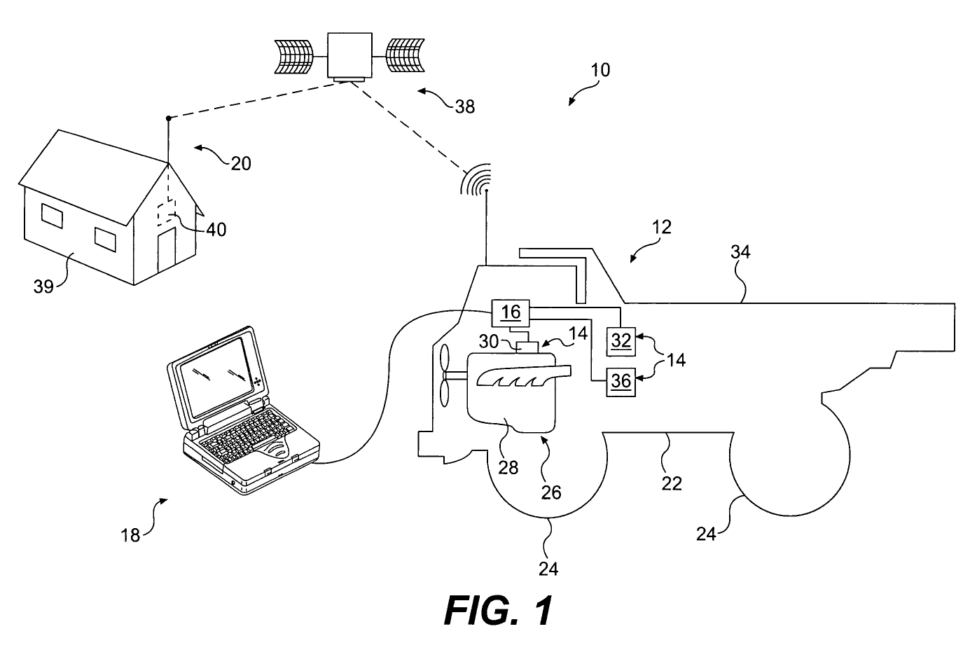

FIG. 1 shows an asset management system 10. System 10 may include a machine 12. System 10 may also include data collection devices 14, a controller 16, and a means for offloading data from machine 12. Such means may include, for example, a hardware interface device 18 or an over-the-air transmission receiving device 20.

Machine 12 may include a frame 22, one or more traction devices 24, and a power source 26. Although machine 12 is shown as a truck, machine 12 could be any type of machine. Accordingly, traction devices 24 may be any type of traction devices, such as, for example, wheels, as shown in FIG. 1, tracks, belts, or any combinations thereof.

Power source 26 may include any type of power source. Power source 26 is illustrated as an internal combustion engine 28. Power source 26 may include any type of internal combustion engine, such as gasoline engines, diesel engines, natural gas engines, etc. Although power source 26 is illustrated as an internal combustion engine, alternatively, power source 26 could be an electrical power source, such as a battery. Power source 26 could also include a hybrid power system, combining, for example, an internal combustion engine with a battery. Power source 26 could also include a fuel cell or may operate on any other kind of alternative fuel (e.g., ethanol, hydrogen, etc.).

Data collection devices 14 may include any kind of sensors or other types of monitoring equipment suitable for monitoring one or more operating conditions of machine 12. In one aspect, data collection devices 14 may be configured to monitor one or more operating parameters of machine 12. For example, system 10 may include an engine monitoring device 30 configured to monitor one or more operating parameters of engine 28. Exemplary engine operating parameters that may be monitored by engine monitoring device 30 include engine hours (i.e., the amount of time the engine runs), engine speed, idle time, engine load, etc.

Data collection devices 14 may also include other equipment for monitoring other operating parameters of machine 12. For example, machine 12 may include a work implement sensor 32. Work implement sensor 32 could be any type of sensor for monitoring the operation of a work tool, such as a bucket, blade, claw, etc. As shown in FIG. 1, work implement sensor 32 may be configured to monitor the operation of a dump body 34 of machine 12. Work implement sensor 32 may be configured to monitor the number of times and/or the speed at which dump body 34 is raised and lowered. Data collection devices 14 may also include other equipment for monitoring other aspects of machine 12, such as transmissions, suspension, and actuators, as well as temperatures and/or pressures of various fluids, such as engine oil, hydraulic fluid, coolant, etc. For example, pressure within shocks or struts of machine 12 may be monitored to determine a payload being transported by a hauling vehicle, such as machine 12. Payload data may provide insight into wear and tear on machine 12.

Machine 12 may also be equipped with one or more atmospheric sensors 36 to monitor other types of operating conditions of machine 12. For example, atmospheric conditions, such as temperature, humidity, precipitation, etc. may be monitored. Other atmospheric conditions may also be monitored, such as dust and other particulates in the air.

Other operating conditions that may be monitored may include geographic parameters, such as information about geographic location. For example, machine 12 may be equipped with a positioning device or system (not shown). One such system may be configured for tracking machine 12 via a global positioning system (GPS). Other geographic parameters may also be monitored such as elevation at a worksite and/or incline of surfaces over which machine 12 may travel.

It should also be noted that more than one of these types of operating conditions may be monitored. For example, machine 12 may be equipped to monitor any combination of operating parameters, geographic parameters, and atmospheric conditions.

Controller 16 may be located anywhere on machine 12 and may include any type of processing device suitable for receiving data from data collection devices 14. Controller 16 may also be configured to facilitate offloading of the data to a location remote from machine 12.

In addition to controller 16, system 10 may include means for offloading data from machine 12. Such means may include a hardware interface device 18 configured to interface with controller 16 or directly with data collection devices 14 to download or otherwise retrieve data from machine 12. For example, hardware interface device 18 may include a laptop or personal digital assistant (PDA) configured to “plug in” to machine 12.

Alternatively or additionally, system 10 may include an over-the-air transmission receiving device 20 configured to retrieve data from machine 12 via “wireless” communication. For example, over-the-air transmission receiving device 20 may include a laptop or PDA configured to retrieve data from machine 12 via a wireless network or Internet connection. In other embodiments, system 10 may be configured to retrieve data from machine 12 from a location remote from machine 12. For example, system 10 may include a satellite 38 configured to receive data from machine 12 and redirect it to a processing center 39 remote from machine 12. Processing center 39 may be located at any distance or location relative to machine 12.

Although various means and methods for offloading data from machine 12 are described herein, these means and methods are exemplary only. The offloading of data from machine 12 may be accomplished in any suitable manner with any suitable means for doing so.

Whether data is retrieved from machine 12 via hardware interface device 18, over-the-air transmission receiving device 20, or some combination thereof, the retrieved data may be directed to a processor 40. Processor 40 may be located on-board machine 12 (e.g., integrated with or otherwise associated with controller 16), integrated with hardware interface device 18, or located at a location remote from machine 12, such as processing center 39. Processing center 39 may be owned, operated, or otherwise associated with a warrantor of machine 12 or a portion thereof. Alternatively, processing center 39 may be owned, operated, or otherwise associated with an owner of machine 12. As used herein, the term owner is intended to broadly cover any person/entity that has rights or interest of any type in the machine at issue, such as, for example, a person with ownership rights (e.g., title) of such machine, a renter or lessee of such machine, a supervisor of the machine operator, or a manager of a worksite at which the machine is operated.

Data collection devices 14 may be configured to monitor operating parameters of machine 12 in real-time. For purposes of this disclosure, the term “real-time” shall refer to the immediate or substantially immediate availability of data to an information system as a transaction or event occurs. That is, data may be retrieved and available for analysis as quickly as it can be transmitted from machine 12 to processor 40. Such transmissions may be virtually instantaneous or may take a few seconds or minutes to complete.

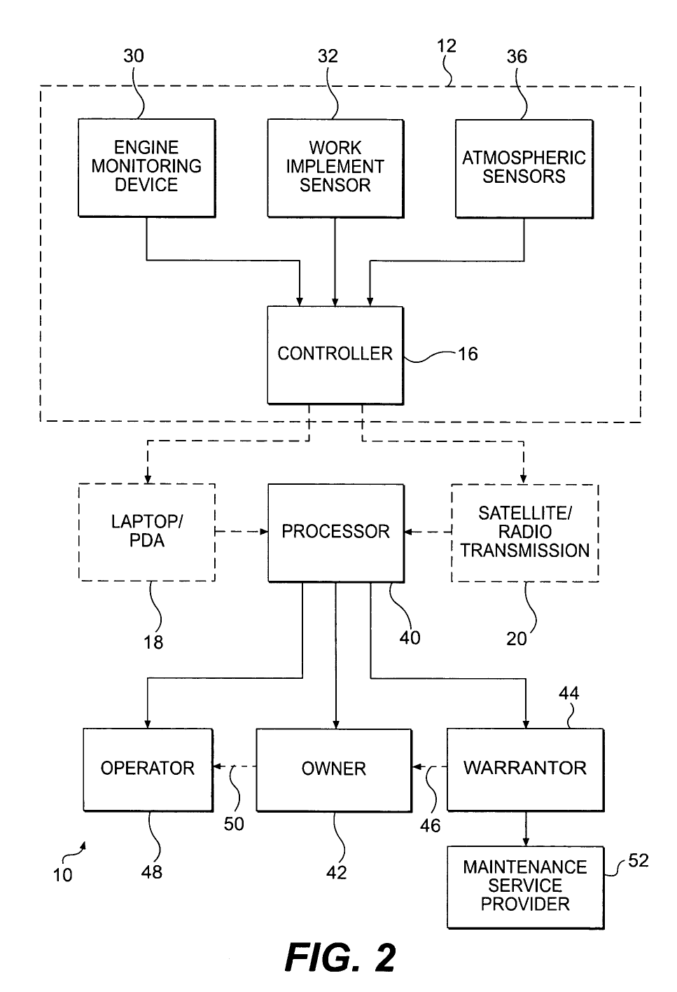

FIG. 2 is a block diagram representation of the flow of data through the various components of system 10. As illustrated by FIG. 2, data may be transmitted from various monitoring equipment, such as engine monitoring device 30, work implement sensor 32, and atmospheric sensors 36, to controller 16. The data may then be transmitted from controller 16 to processor 40 via either hardware interface device 18, over-the-air transmission receiving device 20, or some combination thereof.

Processor 40 may analyze the acquired data. Alternatively or additionally, processor 40 may make information regarding the warrantability of machine 12 under a warranty agreement available for consideration by one or more entities. Such information may include the acquired data, analysis thereof, or any other information relating to the warranty or otherwise desired by an interested party, such as an owner, operator, warrantor, etc. For example, as illustrated in FIG. 2, the information may be forwarded to an owner 42 of machine 12. Alternatively or additionally, the information may be forwarded to a warrantor 44. Although shown as separate, processor 40 may reside with or may be otherwise associated with warrantor 44. The information may be forwarded directly from processor 40 to owner 42, as shown, or from warrantor 44 to owner 42 as indicated by a dashed line 46.

In some embodiments, system 10 may be configured to make the information available to at least one entity other than owner 42. In some embodiments this can be done automatically. One such entity may include an operator 48. It should be noted that owner 42 and operator 48 could be different persons or entities, as illustrated in FIG. 2, or the same person or entity. It should also be noted that the information may be transmitted directly from processor 40 to operator 48. Alternatively or additionally, the information may be transmitted from owner 42 to operator 48, as indicated by a dashed line 50.

System 10 may also be configured to make the information available to a maintenance service provider 52. Maintenance service provider 52 may utilize such information to determine whether certain service, repairs, and/or parts are warrantable. For example, if a hauling vehicle, such as machine 12 were to experience a malfunctioning lift cylinder, then maintenance service provider 52 could refer to the data acquired from machine 12 or the analysis thereof to determine if machine 12 was loaded with a payload above a predetermined maximum set forth in the warranty. If so, maintenance service provider 52 may refuse to perform the repair free of charge as might otherwise be provided for by the warranty. Likewise, warrantor 44 may refuse to honor any such warranty claim, even if maintenance service provider 52 submits for reimbursement.

The information regarding the warrantability of the machine or its components may include one or more types of recommendations. For example, the information may include recommendations for maintenance, such as service, part repair or replacement, component or system overhaul, etc. Alternatively or additionally, the information may include recommendations for one or more operating parameters. For example, system 10 may convey recommendations for optimal or otherwise effective operating parameters, such as engine speed and/or throttle position. An engine speed and/or throttle position that is optimal for fuel efficiency may be recommended. Other exemplary operating parameters may include tire pressures, payloads, etc. In other embodiments, alternative or additional types of recommendations may include one or more operating techniques. In an exemplary embodiment, system 10 may convey recommendations for optimal or otherwise effective operating techniques. For example, system 10 may provide recommendations for ground speed of a loader for crowding a pile of material (e.g., picking up a bucketful of dirt).

Any of these recommendations may be aimed at optimizing or otherwise improving any aspect or aspects of machine performance or longevity. In the example of recommending ground speed of a loader for crowding a pile of material, the ground speed may be optimized for a variety of aspects, such as fuel efficiency, effectiveness at picking up the material, wear and tear on machine 12. In some embodiments, system 10 may provide recommendations for operating machine 12 within the limits of usage rules of a warranty agreement. For example, system 10 may indicate a maximum allowable payload under the warranty. The maximum allowable payload under the warranty may be any payload, and may be set relative to a maximum payload for which machine 12 is designed and/or rated.

Such recommendations may be initiated by any type of trigger. For example, the recommendations may be conveyed on a periodic bases as regular reminders (e.g., annual maintenance, such as belt replacement or other service). Other types of recommendations may be triggered at intervals of machine usage (e.g., oil changes at intervals of a predetermined number of engine hours). Other types of recommendations may be triggered by data acquired outside of a predetermined specification (e.g., engine speed above a predetermined threshold). An exemplary predetermined specification may include specifications set forth in a warranty agreement. For example, recommendations may be conveyed if and when machine 12 is utilized to carry a payload above a maximum payload allowable under the warranty.

Further, information regarding the warrantability of machine 12 or its components may include an offer of an opportunity to modify the set of usage terms of a warranty agreement. For example, if a warranty allows for 1500 engine hours per year, and an owner exceeds this limit by operating machine 12 for 2000 hours in a year, then system 10 may convey an offer for the owner to modify the warranty to allow 2200 hours per year in the future.

System 10 may be configured to suggest changes in operating conditions to one or more entities interested in machine 12. For example, system 10 may be configured to suggest, to an owner and/or operator, changes in operating conditions that may have a positive impact on one or more aspects of machine operation. Such aspects may include productivity, operating expenses,. longevity, etc. These aspects may be related to or otherwise associated with the warrantability of machine 12 or portions thereof. System 10 may be configured to suggest one or more preferred sets of operating conditions that may optimize the performance/efficiency and/or minimize wear and tear on machine 12. For example, system 10 may be configured to recommend various types of maintenance (e.g., oil changes, component replacement, etc.) or operating parameters and/or techniques (e.g., how much throttle to use during particular tasks, proper tire pressure, etc.).

System 10 may be configured to deliver such recommendations to owners, operators, and/or any other interested party in a variety of ways. The suggestions may be emailed to the interested parties or made available via a local or global webpage (e.g., the Internet). The suggestions may be delivered to processing center 39 and/or to machine 12. For example, visual and/or audio alerts may be provided to an operator of machine 12 that indicate via an on-board display/alert system (not shown) recommended operating parameters for optimizing various aspects of machine operation and/or longevity.

System 10 may be configured to convey other information to owners, operators, and/or any other interested party regarding the warranty agreement of machine 12 or its components. Such information may include an offer of an opportunity to modify a set of usage terms of the warranty agreement. System 10 may also be configured to automatically change one or more of the usage terms of the warranty agreement. Further, the information conveyed may include a notification of the change in the one or more usage terms of the warranty agreement.

### INDUSTRIAL APPLICABILITY

The disclosed asset management system may be applicable for management of any kind of mechanical equipment asset for which operating data may be retrieved. For example, the disclosed system may be used for management of machines, such as heavy duty equipment (e.g., excavators, track-type tractors, loaders, power generation sets, etc.) and/or light duty equipment (e.g., passenger vehicles, small-sized electric generators, lawn and garden tractors, etc.). Further, the disclosed system may be used to manage a fleet of one or more different types of machines.

The disclosed system may be utilized for on-site monitoring of machines at a worksite. Data may be retrieved and analyzed on location at the worksite. Alternatively or additionally, the disclosed system may be utilized for monitoring of machines from a remote location. Data may be analyzed at a processing center remote from the machine, such as a service or management center. For such remote analysis, the data may be retrieved on location at the worksite or delivered to processing center via a data transfer link (e.g., satellite communication).

The retrieved data may be examined by an individual (e.g., an owner, operator, service technician, etc.) or by the disclosed system itself to monitor any of a number of operating parameters. An exemplary method of using system 10 may include processing this data and comparing the collected data to a set of usage terms of a warranty agreement relating to machine 12. Such a method may also include communicating, in real time, to at least one of an owner and an operator, information regarding the warrantability of machine 12 or its components under the warranty agreement based on the comparison of the collected data to the set of usage terms of the warranty agreement.

An exemplary method of using system 10 may further include monitoring operating parameters of machine 12. Such a method may include at least two of the following: operating parameters of the machine, geographic parameters, and atmospheric conditions. The method may also include offloading the data from machine 12 and making the data available for consideration by one or more entities. The method may include making the data available to at least one entity other than an owner of the machine, such as, for example, a maintenance service provider.

An exemplary method of using system 10 may include recommending, to at least one of an owner and an operator of the machine, at least one of the following: maintenance, one or more operating parameters, and one or more operating techniques. Communicating information may include offering, to at least one of an owner and an operator, an opportunity to change the set of terms of the warranty agreement. The method may also include automatically changing one or more of the usage terms of the warranty agreement. The communicated information may include a notification of the change in the one or more usage terms of the warranty agreement.

The disclosed system may be configured to process the acquired data at any location. The disclosed system may also be configured to transmit the data and/or analysis thereof, as well as other information related thereto to any location and/or entity. For example, in one embodiment, system 10 may be configured to acquire data on-board machine 12, offload the data to a remote location for processing (e.g., processing center 39), and provide feedback information to on-board systems of machine 12 for display and/or storage. Part or all of this process may be executed to provide the feedback in real-time with respect to the acquired data. In another exemplary embodiment, system 10 may be configured to acquire data on-board machine 12, process the data on-board machine 12, and offload analysis and/or other information relating to the data to a remote location/entity, thus providing the remote location/entity with real time data, analysis, and/or information. In yet another exemplary embodiment, system 10 may be configured to acquire data on-board machine 12, offload the data to a remote location for processing (e.g., processing center 39), and forward the data/analysis/information to an location/entity remote from machine 12. Again, part or all of this process may be executed in real time.

It will be apparent to those having ordinary skill in the art that various modifications and variations can be made to the disclosed asset management system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. An asset management system, comprising:
one or more data collection devices configured to monitor one or more operating conditions of a machine in real time; and
a processor configured to:
receive data from the one or more data collection devices;
compare the received data to a set of usage terms of a warranty agreement relating to the machine;
wherein the system is configured to communicate, in real time, to at least one of an owner and an operator, information regarding the warrantability of the machine or its components under the warranty agreement based on the comparison of the received data to the set of usage terms of the warranty agreement.

2. The system of claim 1, wherein the one or more operating conditions includes operating parameters of the machine.

3. The system of claim 1, wherein the one or more operating conditions includes at least two of the following:
operating parameters of the machine;
geographic parameters; and
atmospheric conditions.

4. The system of claim 1, wherein the system is configured to offload the data from the machine and make the data available for consideration by one or more entities.

5. The system of claim 4, wherein the system is configured to automatically make the data available to at least one entity other than an owner of the machine.

6. The system of claim 5, wherein the at least one entity includes a maintenance service provider.

7. The system of claim 1, wherein the information regarding the warrantability of the machine or its components includes recommendations for at least one of the following:
maintenance;
one or more operating parameters; and
one or more operating techniques.

8. The system of claim 1, wherein the information regarding the warrantability of the machine or its components includes an offer of an opportunity to modify the set of usage terms of the warranty agreement.

9. The system of claim 1, wherein the system is configured to automatically change one or more of the usage terms of the warranty agreement.

10. The system of claim 9, wherein the communicated information includes a notification of the change in the one or more usage terms of the warranty agreement.

11. A method of asset management, comprising:
monitoring one or more operating conditions of a machine in real time;
collecting data for the one or more operating conditions;
comparing the collected data to a set of usage terms of a warranty agreement relating to the machine; and
communicating, in real time, to at least one of an owner and an operator, information regarding the warrantability of the machine or its components under the warranty agreement based on the comparison of the collected data to the set of usage terms of the warranty agreement.

12. The method of claim 11, wherein the one or more operating conditions includes operating parameters of the machine.

13. The method of claim 11, wherein the one or more operating conditions includes at least two of the following:
operating parameters of the machine;
geographic parameters; and
atmospheric conditions.

14. The method of claim 11, further including offloading the data from the machine and making the data available for consideration by one or more entities.

15. The method of claim 11, automatically making the data available to at least one entity other than an owner of the machine.

16. The method of claim 15, wherein the at least one entity includes a maintenance service provider.

17. The method of claim 16, further including recommending, to at least one of an owner and an operator of the machine, at least one of the following:
maintenance;
one or more operating parameters; and
one or more operating techniques.

18. The method of claim 11, wherein communicating information includes offering, to at least one of an owner and an operator, an opportunity to change the set of terms of the warranty agreement.

19. The method of claim 11, further including automatically changing one or more of the usage terms of the warranty agreement.

20. The method of claim 19, wherein the communicated information includes a notification of the change in the one or more usage terms of the warranty agreement.

21. A machine, comprising:
a frame; and
a power source mounted to the frame;
wherein the machine is integrated with an asset management system including:
one or more data collection devices configured to monitor one or more operating conditions of the machine in real time; and
a processor configured to:
receive data from the one or more data collection devices;
compare the received data to a set of usage terms of a warranty agreement relating to the machine; and
wherein the system is configured to communicate, in real time, to at least one of an owner and an operator, information regarding the warrantability of the machine or its components under the warranty agreement based on the comparison of the received data to the set of usage terms of the warranty agreement.

22. The machine of claim 21, wherein the one or more operating conditions includes operating parameters of the machine.

23. The machine of claim 21, wherein the one or more operating conditions includes at least two of the following:
operating parameters of the machine;
geographic parameters; and
atmospheric conditions.

24. The machine of claim 21, wherein the system is configured to automatically make the data available to at least one entity other than an owner of the machine.

25. The machine of claim 21, wherein the system is configured to offload the data from the machine and make the data available for consideration by one or more entities.

26. The machine of claim 21, wherein the system is configured to automatically make the data available to at least one entity other than an owner of the machine.

27. The machine of claim 26, wherein the at least one entity includes a maintenance service provider.

28. The machine of claim 21, wherein the information regarding the warrantability of the machine or its components includes recommendations for at least one of the following:
maintenance;
one or more operating parameters; and
one or more operating techniques.

29. The machine of claim 21, wherein the information regarding the warrantability of the machine or its components includes an offer of an opportunity to modify the set of usage terms of the warranty agreement.

30. The machine of claim 21, wherein the system is configured to automatically change one or more of the usage terms of the insurance policy.

31. The machine of claim 30, wherein the communicated information includes a notification of the change in the one or more usage terms of the insurance policy.
